(19) United States
(12) Patent Application Publication
(10) Pub. No.: US 2008/0071930 A1
(43) Pub. Date: Mar. 20, 2008

(54) Native network transport

(76) Inventors: Kenneth J. Holbrook, Cary, NC (US); Brett D. McDonald, Seneca, SC (US)

Correspondence Address: DORITY & MANNING, P.A., POST OFFICE BOX 1449, GREENVILLE, SC, 29602-1449, US

(21) Appl. No.: 11/897,233

(22) Filed: Aug. 29, 2007

Related U.S. Application Data
(60) Provisional application No. 60/841,997, filed on Sep. 1, 2006.

(51) Int. Cl. G06F 15/173; G08B 23/00; G08C 15/06

(52) U.S. Cl. 709/250; 340/870.02

(57) ABSTRACT

Disclosed are apparatus and methodology subject matters for providing a Native Network Interface within an Advanced Metering System (AMS). The Native Network Interface provides the ability to plug in different low level network transport layers into a metering system to provide access to the physical network protocol from a C12.22 protocol stack in C12.22 Host applications. The design includes a base class having selected capabilities that may be reused in development of a transport layer for providing reliable message transport between communications system coupled components in an Advanced Metering System.

### PRIORITY CLAIM

This application claims the benefit of previously filed U.S. Provisional Patent Application entitled “NATIVE NETWORK TRANSPORT,” assigned U.S. Ser. No. 60/841,997, filed Sep. 1, 2006, and which is hereby incorporated herein by reference in its entirety for all purposes.

### FIELD OF THE INVENTION

The present technology relates to utility meter communication networks. More particularly, the present technology relates to apparatus and methodologies for providing reliable message transport between communications system coupled components in an Advanced Metering System (AMS).

### BACKGROUND OF THE INVENTION

The general object of metrology is to monitor one or more selected physical phenomena to permit a record of monitored events. Such basic purpose of metrology can be applied to a variety of metering devices used in a number of contexts. One broad area of measurement relates, for example, to utility meters. Such role may also specifically include, in such context, the monitoring of the consumption or production of a variety of forms of energy or other commodities, for example, including but not limited to, electricity, water, gas, or oil.

More particularly concerning electricity meters, mechanical forms of registers have been historically used for outputting accumulated electricity consumption data. Such an approach provided a relatively dependable field device, especially for the basic or relatively lower level task of simply monitoring accumulated kilowatt-hour consumption.

The foregoing basic mechanical form of register was typically limited in its mode of output, so that only a very basic or lower level metrology function was achieved. Subsequently, electronic forms of metrology devices began to be introduced, to permit relatively higher levels of monitoring, involving different forms and modes of data.

In the context of electricity meters specifically, for a variety of management and billing purposes, it became desirable to obtain usage data beyond the basic kilowatt-hour consumption readings available with many electricity meters. For example, additional desired data included rate of electricity consumption, or date and time of consumption (so-called “time of use” data). Solid state devices provided on printed circuit boards, for example, utilizing programmable integrated circuit components, have provided effective tools for implementing many of such higher level monitoring functions desired in the electricity meter context.

In addition to the beneficial introduction of electronic forms of metrology, a variety of electronic registers have been introduced with certain advantages. Still further, other forms of data output have been introduced and are beneficial for certain applications, including wired transmissions, data output via radio frequency transmission, pulse output of data, and telephone line connection via such as modems or cellular linkups.

The advent of such variety and alternatives has often required utility companies to make choices about which technologies to utilize. Such choices have from time to time been made based on philosophical points and preferences and/or based on practical points such as, training and familiarity of field personnel with specific designs.

Another aspect of the progression of technology in such area of metrology is that various retrofit arrangements have been instituted. For example, some attempts have been made to provide basic metering devices with selected more advanced features without having to completely change or replace the basic meter in the field. For example, attempts have been made to outfit a basically mechanical metering device with electronic output of data, such as for facilitating radio telemetry linkages.

Another aspect of the electricity meter industry is that utility companies have large-scale requirements, sometimes involving literally hundreds of thousands of individual meter installations, or data points. Implementing incremental changes in technology, such as retrofitting new features into existing equipment, or attempting to implement changes to basic components which make various components not interchangeable with other configurations already in the field, can generate considerable industry problems.

Electricity meters typically include input circuitry for receiving voltage and current signals at the electrical service. Input circuitry of whatever type or specific design for receiving the electrical service current signals is referred to herein generally as current acquisition circuitry, while input circuitry of whatever type or design for receiving the electrical service voltage signals is referred to herein generally as voltage acquisition circuitry.

Electricity meter input circuitry may be provided with capabilities of monitoring one or more phases, depending on whether monitoring is to be provided in a single or multiphase environment. Moreover, it is desirable that selectively configurable circuitry may be provided so as to enable the provision of new, alternative or upgraded services or processing capabilities within an existing metering device. Such variations in desired monitoring environments or capabilities, however, lead to the requirement that a number of different metrology configurations be devised to accommodate the number of phases required or desired to be monitored or to provide alternative, additional or upgraded processing capability within a utility meter.

More recently a new ANSI protocol, ANSI C12.22, is being developed that may be used to permit open protocol communications among metrology devices from various manufacturers. C12.22 is the designation of the latest subclass of the ANSI C12.xx family of Meter Communication and Data standards presently under development. Presently defined standards include ANSI C12.18 relating to protocol specifications for Type 2 optical ports; ANSI C12.19 relating to Utility industry Meter Data Table definitions; and ANSI C12.21 relating to Plain Old Telephone Service (POTS) transport of C12.19 Data Tables definition. It should be appreciated that while the remainder of the present discussion may describe C12.22 as a standard protocol, that, at least at the time of filing the present application, such protocol is still being developed so that the present disclosure is actually intended to describe an open protocol that may be used as a communications protocol for networked metrology and is referred to for discussion purposes as the C12.22 standard or C12.22 protocol.

C12.22 is an application layer protocol which provides for the transport of C12.19 data tables over any network medium. Current standards for the C12.22 protocol include: authentication and encryption features; addressing methodology providing unique identifiers for corporate, communication, and end device entities; self describing data models; and message routing over heterogeneous networks.

Much as HTTP protocol provides for a common application layer for web browsers, C12.22 provides for a common application layer for metering devices. Benefits of using such a standard include the provision of: a methodology for both session and session less communications; common data encryption and security; a common addressing mechanism for use over both proprietary and non-proprietary network mediums; interoperability among metering devices within a common communication environment; system integration with third-party devices through common interfaces and gateway abstraction; both 2-way and 1-way communications with end devices; and enhanced security, reliability and speed for transferring meter data over heterogeneous networks.

To understand why utilities are keenly interested in open protocol communications; consider the process and ease of sending e-mails from a laptop computer or a smart phone. Internet providers depend on the use of open protocols to provide e-mail service. E-mails are sent and received as long as e-mail addresses are valid, mail boxes are not full, and communication paths are functional. Most e-mail users have the option of choosing among several internet providers and several technologies, from dial-up to cellular to broadband, depending mostly on the cost, speed, and mobility. The e-mail addresses are in a common format, and the protocols call for the e-mail to be carried by communication carriers without changing the e-mail. The open protocol laid out in the ANSI C.12.22 standard provides the same opportunity for meter communications over networks.

In addition, the desire for increased processing capabilities as well as other considerations including, but not limited to, a desire to provide reliable transportation of communications between Advanced Metering System (AMS) components, leads to requirements for supplying communications capabilities to a significant number of meters that may be installed over a significant area often encompassing many square miles.

As such, it is desired to provide a universal metrology technology and associated methodology that permits native network transportation of communications within a metrology system. While various aspects and alternative embodiments may be known in the field of utility metering, no one design has emerged that generally encompasses the above-referenced characteristics and other desirable features associated with utility metering technology as herein presented.

### SUMMARY OF THE INVENTION

In view of the recognized features encountered in the prior art and addressed by the present subject matter, an improved apparatus and methodology for providing reliable message delivery between the Collection Engine host processors and other network nodes has been provided.

In an exemplary arrangement, a methodology has been provided to provide different low level network transport layers using common interfaces.

In one of its simpler forms, the present technology provides for the use of .NET interfaces to provide differing network transport layers depending on network communication requirements.

One positive aspect of this type of arrangement is that reliable message delivery can be achieved with differing low level transport layers by reusing a common base class to develop the transport level.

Another positive aspect of this rebalancing is that it improves opportunities to receive exception reports from end devices.

Yet another positive aspect of type of arrangement is that the base class includes access to standard components that may be used in various implementations of differing interfaces.

One present exemplary embodiment relates to an advanced metering system including a native network interface for interfacing among selected layers in an open standard meter communication protocol stack. Such a present advanced metering system may preferably include a plurality of end devices, a network, and a network interface. Such plurality of end devices preferably includes at least some metrology devices. Such exemplary network feature preferably includes a central facility comprising a collection engine, with such network being configured for bi-directional communications between such central facility and each of such plurality of end devices, with such bi-directional communications occurring at least in part based on an open standard meter communication protocol. Such present exemplary network interface feature preferably is provided for operation on processors associated with selected ones of such plurality of end devices and such collection engine, with such network interface being operative for providing access to the network protocol of such open standard meter communication protocol.

In various alternative configurations of the foregoing exemplary embodiment, such advanced metering system may further include one or more communication nodes associated with such plurality of end devices, and with such network interface being further configured to send messages out a network interface, and to listen for incoming messages on ports associated with such one or more communication nodes associated with such plurality of end devices.

Still further, such network interface may be further configured to assemble messages into complete application responses for sending positive or negative acknowledgement of messages sent to or received from another communication node in the advanced metering system.

In yet further alternative configurations of the foregoing, such metrology devices may comprise meters (such as electricity meters, or other types) having one or more of GPRS, Ethernet, and RF LAN communications modules.

Still further present exemplary embodiments more directly relate to present methodology. One present exemplary method may relate to a method of interfacing among selected layers in an open standard meter communication protocol stack, with such open standard meter communication protocol stack being used for communicating information among a plurality of communication nodes associated with an advanced metering system. Such an exemplary present method may comprise steps of providing an ability to plug in one or more transport layers; providing access to the network protocol from the open standard meter communication protocol stack; and providing methods for sending and receiving data to other communication nodes in the advanced metering system. Alternative embodiments of such methodology may further include developing a transport layer, and providing a common base class for reuse in development of such transport layer. In such context, one or more of such transport layers may be provided as capable of being plugged into a developed transport layer interface comprising one or more of Transmission Control Protocol/Internet Protocol (TCP/IP) and User Datagram Protocol (UDP) transport layers.

Still further alternative present methodologies may additionally include providing access to a standard logging mechanism and/or providing access to common instrumentation, and/or providing access to network interface management including status and diagnostic reporting.

In still other present alternative methodologies, a given native network address may be maintained, and one or more host applications notified if the given native network address changes.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents including combinations of features, parts, or steps or configurations thereof not expressly shown in the figures or stated in the detailed description of such figures. Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a block diagram overview illustration of an Advanced Metering System (AMS) in accordance with the present subject matter;

FIG. 2 illustrates a block diagram of the components of a collection engine in accordance with an exemplary embodiment of the present subject matter; and

FIG. 3 illustrates a block diagram of an exemplary meter incorporating interface features in accordance with the present subject matter.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with an improved apparatus and methodology for providing reliable message delivery between the Collection Engine host processors and other network nodes.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

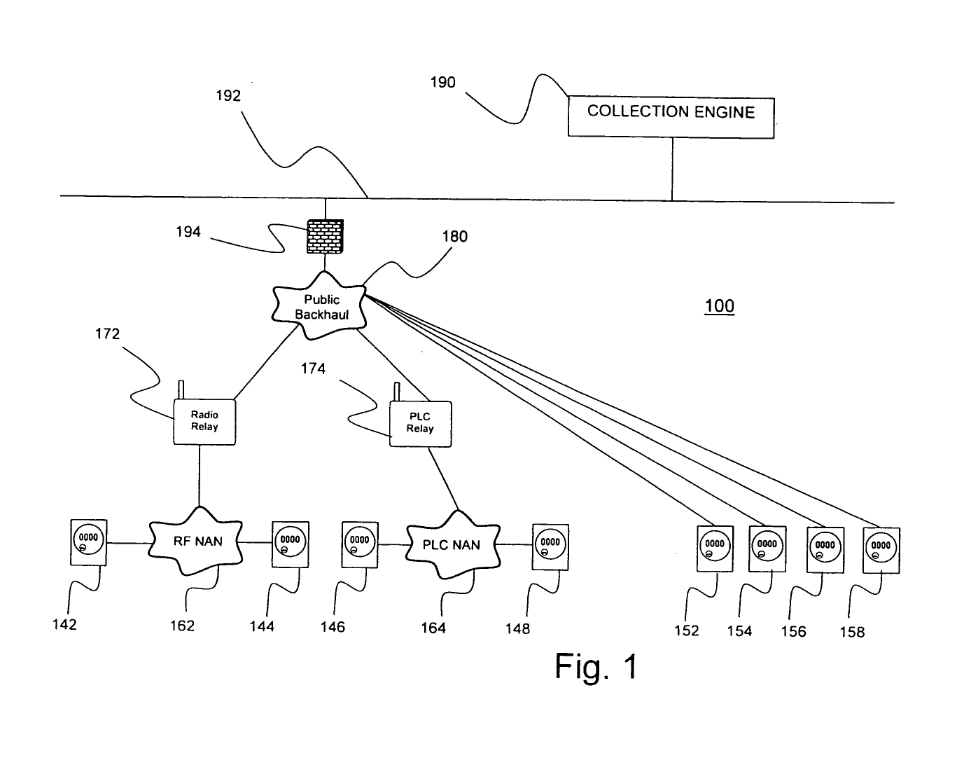

Reference will now be made in detail to the presently preferred embodiments of the subject firmware download methodology and apparatus. Referring now to the drawings, FIG. 1 is a block diagram overview illustration of an Advanced Metering System (AMS) in accordance with the present subject matter.

Advanced Metering System (AMS) 100 in accordance with the present subject matter is designed to be a comprehensive system for providing advanced metering information and applications to utilities. AMS 100 is build around industry standard protocols and transports, and is designed to work with standards compliant components from third parties.

Major components of AMS 100 include meters 142, 144, 146, 148, 152, 154, 156, 158; one or more radio networks including RF neighborhood area network (RF NAN) 162 and accompanying Radio Relay 172 and power line communications neighborhood area network (PLC NAN) 164 and accompanying PLC Relay 174; an IP based Public Backhaul 180; and a Collection Engine 190. Other components within AMS 100 include a utility LAN 192 and firewall 194 through which communications signals to and from Collection Engine 190 may be transported from and to meters 142, 144, 146, 148, 152, 154, 156, 158 or other devices including, but not limited to, Radio Relay 172 and PLC Relay 174.

AMS 100 is configured to be transportation agnostic or transparent; such that meters 142, 144, 146, 148, 152, 154, 156, 158 may be interrogated using Collection Engine 190 regardless of what network infrastructure lay in between. Moreover, due to this transparency, the meters may also respond to Collection Engine 190 in the same manner.

As illustrated in FIG. 1, Collection Engine 190 is capable of integrating Radio, PLC, and IP connected meters. To facilitate this transparency, AMS 100 uses ANSI C12.22 meter communication protocol for networks. C12.22 is a network transparent protocol, which allows communications across disparate and asymmetrical network substrates. C12.22 details all aspects of communications, allowing C12.22 compliant meters produced by third parties to be integrated into a single advanced metering interface (AMI) solution. AMS 100 is configured to provide meter reading as well as load control/demand response, in home messaging, and outage and restoration capabilities. All data flowing across the system is sent in the form of C12.19 tables. The system provides full two-way messaging to every device; however, many of its functions may be provided through broadcast or multicast messaging and session-less communications.

In accordance with the present subject matter, the disparate and asymmetrical network substrates may be accommodated by way of a native network interface having the capability to plug in different low level transport layers using NET interfaces. In accordance with an exemplary configuration, Transmission Control Protocol/Internet Protocol (TCP/IP) may be employed and the remainder of the present discussion is directed to such a choice of transport layer. It should be appreciated, however, that TCP/IP is not the only such low level transport layer protocol available and that other protocols such as User Datagram Protocol (UDP) may be used.

A Native Network Interface in accordance with the present technology provides access to the physical, i.e., native, network protocol from the C12.22 protocol stack in C12.22 Host applications. The design includes a base class for reuse in development of the transport layer. The main interface methods provide standard sessionless server and client methods for sending and receiving data although session-based communication may also be employed. The base class also includes access to a standard logging mechanism, common instrumentation through Windows Management Instrumentation (WMI), and standard status and diagnostic reporting. A static method is used to load the transport layer assembly, transparently to the client application. The transport layer assemblies may be configurable to include more control over incoming messages to accommodate variable length messages more efficiently, and provide a configurable security interface.

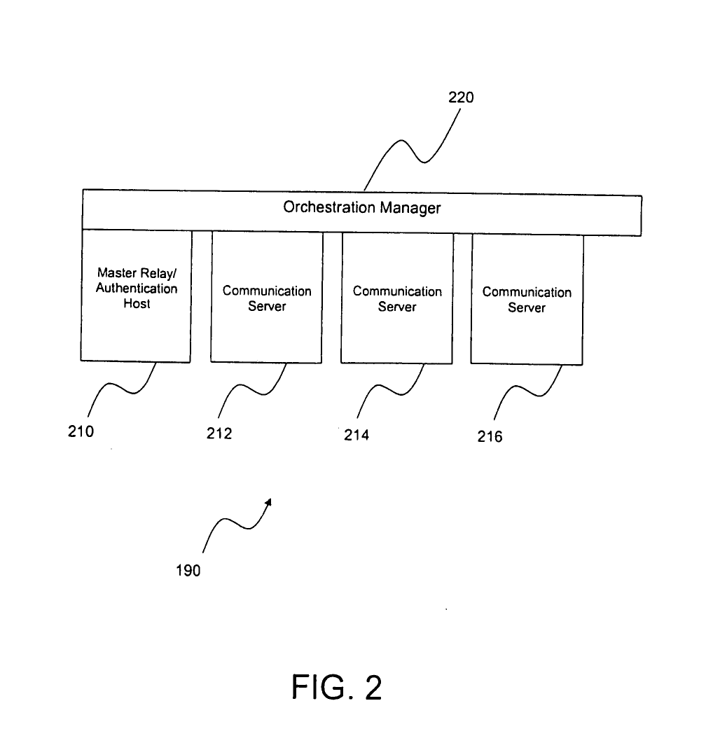

With reference now to FIG. 2, there is illustrated a block diagram representation of components of collection engine 190 in accordance with an exemplary embodiment of the present subject matter. Collection engine 190 is a collection of software services which provides C12.22 services to the devices that comprise the C12.22 network including one or more cell relays 172, 174 (FIG. 1) as well as the metrology and end devices 142, 144, 146, 148, 152, 154, 156, 158 (FIG. 1). Conceptually, the collection engine 190 is comprised of three major components, the Orchestration Manager 220, the master relay/authentication host 210, and the communications server(s) 212, 214, 216.

Orchestration Manager 220 controls the allocation of C12.22 nodes to a variable number of communication servers. Multiple communication servers 212, 214, 216 are used for scalability and redundancy. An allocation algorithm provides load balancing in the Collection Engine 190. Load balancing affects two aspects of data collection: contacting end devices to read data, and receiving exception reports from end devices. A rebalancing function runs periodically to reallocate nodes among communication servers maintaining efficiency of data collection. The rebalancing function also redistributes end devices from a failed communication server to the other active servers, and to a communication server that becomes active. All requests for end-device communications are routed through Orchestration Manager 220. A job system is used to organize and track actions currently in progress on communication servers 212, 214, 216; pass large-scale interrogation parameters to the communication servers; receive status from the communication servers; and provide persistence of collection engine state information in case of failover to an un-illustrated backup Orchestration Manager or communication server. In its role as a C12.22 Notification Host, Orchestration Manager 220 coordinates registration-related processing on communication servers 212, 214, 216.

Within a C12.22 system, the master relay 210 is the coordinating process for the overall system. In order to send or receive C12.22 messages, nodes 142, 144, 146, 148, 152, 154, 156, and 158 must be registered with the Master Relay. Before a node is allowed to register though, it must be authenticated. The authentication host provides this service. The master station is responsible for the actual meter data acquisition process, communicating with the meter via C12.22 messages. In order to facilitate scaling the collection engine 190 will be able to distribute work across multiple servers 212, 214, 216.

Each of these major components is made up of a series of smaller services and components. The orchestration layer 220 provides coordination between the components, and presents a unified, single API to up stream systems. The Orchestration Manager 220 runs as a single master orchestration service and a series of orchestration agents associated with each separate physical server. API requests are directed to the master orchestration service which in turn works with the orchestration agents to ensure that requested work is performed.

The master relay/authentication host will provide standard C12.22 registration services as well as integrated C12.22 network authentication services. One vision for the C12.22 protocol is that, similar to DNS, a C12.22 master relay may be created which would be shared between multiple utilities, perhaps providing services to an entire region or country. With this in mind, implementation of the master relay should provide full support for the use of other authentication hosts, and for sending notification messages to registered hosts. Additionally, the Orchestration Manager 220 is able to receive notifications from master relays from other manufacturers, meaning that an implementation of the present subject matter could be brought on-line employing a master relay from an outside source.

The communications servers 212, 214, 216 provide communication services with devices, parse and translate those communications, and post or return data as necessary. Communication servers 212, 214, 216 thus made up a series of services to accomplish this. Within communications servers 212, 214, 216 are a series of major components: the meter communications host, the data spooler, and the exception event manager. The meter communications host is responsible for listening for network communications and sending network communications. It is the component that both “speaks” C12.22 and “interprets” C12.19 table data. The data spooler and the exception event manager, provide mechanisms for streaming meter data and exception events, respectively, to upstream systems.

The Native Network Interface in accordance with the present technology is responsible for providing reliable message delivery, as defined by the C12.22 standard, between the Collection Engine 190 host processors and other network nodes using network protocols underlying the C12.22 network. The Native Network Interface includes sub-components for sending messages out a network interface, listening for incoming messages on ports, assembling messages into complete application responses, providing asynchronous message processing including message queues and thread management for port listeners, and providing network interface management including status and diagnostic reporting.

Reliable message delivery means that Native Network transport will always provide positive or negative acknowledgment of message receipt at the destination node. Additionally, positive or negative acknowledgment is provided in response to each inbound message from a C12.22 node. These features may, however, be dependent on the capabilities of the underlying network protocol, and C12.22 end node capabilities. The Native Network Interface provides interfaces to Collection Engine applications such that the native network protocol may be changed as necessary (e.g. TCP or UDP).

While the Native Network Interface is designed primarily to support the C12.22 Manager, the interface is sufficiently general purpose to support other inter-process communications if necessary. The Native Network Interface supports client and server processing for consumers of its interfaces, as well as status and diagnostic functions. Client processing is supported by interfaces that send requests which return data or status results from destination nodes with options to wait for resulting data synchronously or asynchronously. Server processing is supported by interfaces that set up a listening port and return complete messages from remote nodes to waiting functions in the host application.

The Native Network Interface includes logic to keep its native address from changing due to inactivity. If the native address does change, Native Network transport has capability to notify a host application immediately. The native address is always available to applications via an exposed interface.

The Native Network Interface is designed to execute within a multi-threaded process and uses multiple threads for its own processing. Threads may be used to send requests, receive asynchronous responses, listen for incoming messages on a port, and process messages asynchronously for the listener port.

The TCP/IP instance of the Native Network Interface, the Interface uses inherent protocol features for reliable message delivery. It relies on built-in functions such as TraceRoute and Ping to collect diagnostic information. Status information for the local network interface is provided on demand. Additional status and diagnostic information for remote nodes may be provided based on the capability of remote nodes such as Cell Relays. Inbound connections for host server functions may be processed on asynchronous sockets so as to not block the listener port. A response assembler continues reading incoming TCP/IP packets and building a request/response for the host application until a complete TCP/IP message has been received. Messages that cannot be successfully assembled will be returned to the host application as partial messages with an error condition indicated. Any detailed information related to the failure will be logged locally.

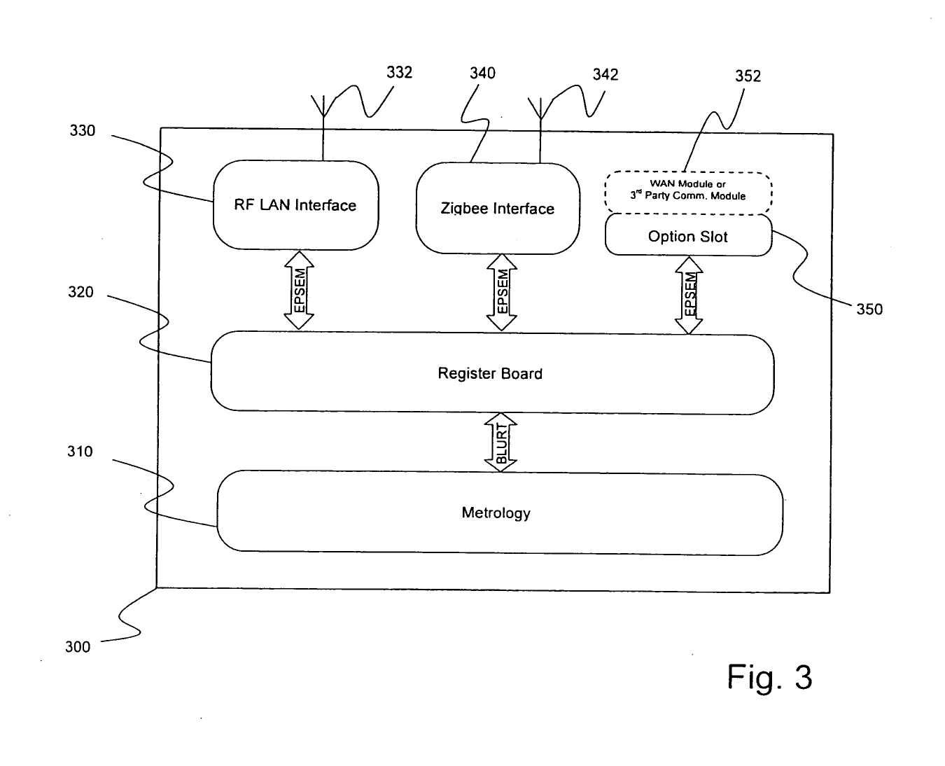

With reference now to FIG. 3, there is illustrated a block diagram of an exemplary meter 300 incorporating interface features in accordance with the present subject matter. Meter 300 incorporates several major components including metrology 310, a register board 320 and one or more communications devices. In the presently illustrated configuration, meter 300 may include an RF LAN Interface 330 and accompanying antenna 232 and a Zigbee Interface 340 and its accompanying antenna 342. In addition, an Option Slot 350 may be provided to accommodate a third party network or communications module 352.

Metrology 310 may correspond to a solid-state device configured to provide an internal C12.18 blurt communications to register board 320. Communications within meter 300 is conducted via C12.22 Extended Protocol Specification for Electronic Metering (EPSEM) messages. The meter register board 320 is configured to fully support C12.19 tables and C12.22 extensions. While all meter data will be accessible via standard C12.19 tables, in order to facilitate very low bandwidth communications, manufacturers tables or stored procedures are included which provide access to specific time-bound slices of data, such as the last calendar day's worth of interval data or other customized “groupings” of data.

Meter 300 may be variously configured to provide differing communications capabilities. In exemplary configurations, one or more of GPRS, Ethernet, and RF LAN communications modules may be provided. GPRS will allow meters to be IP addressable over a public backhaul and provide more bandwidth than the meter will ever require, but may incur ongoing subscriptions costs. Ethernet connectivity can be used to bridge to third party technologies, including WiFi, WiMax, in-home gateways, and BPL, without integrating any of these technologies directly into the metering device, but with the tradeoff of external wiring and a two part solution. Ethernet devices may be used primarily in pilots and other special applications; though they may be ideal for certain high-density RF-intolerant environments such as meter closets.

Due to the increased complexity of managing a WAN interface, with its more sophisticated link negotiation requirements and TCP/IP stack, WAN connected meters may include an additional circuit board dedicated to WAN connectivity. This board will interface with meter 300 using EPSEM messages and Option Slot 350.

The availability of Option Slot 350 within meter 300 provides the advantage that it will make meter 300 available for integration with third party backhauls, such as PLC. In order for such third party devices to be integrated into AMS 100, on the other hand, third party devices will need to include both a communications board and a C12.22 compliant relay to couple communications signals from the third party's proprietary network to an IP connection. Alternatively, third parties could integrate meter 300 it into their own end-to-end solution.

The communications protocol between meter 300 and communications modules 330, 340, and WAN module or optional third part communications module 350 follow the C12.22 standards, allowing any third party to design to the standard and be assured of relatively straightforward integration.

Communication to the Collection Engine 190 is performed over an Internet Protocol connection. The Wide-Area-Network is a fully routable, addressable, IP network that may involve a variety of different technologies including, but not limited to, GPRS, WiFi, WiMax, Fiber, Private Ethernet, BPL, or any other connection with sufficiently high bandwidth and ability to support full two-way IP communication. Several assumptions may be made regarding the IP WAN. Collection Engine 190 is assumed to be able to communicate directly with other nodes on the IP WAN. While communications may be conducted through a firewall 194, it is not necessary that such be proxied, unless the proxy is itself a C12.22 node functioning as a relay between a private IP network and the public IP WAN.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of interfacing among selected layers in an open standard meter communication protocol stack, said open standard meter communication protocol stack used for communicating information among a plurality a communication nodes associated with an advanced metering system, said method comprising the steps of:
providing an ability to plug in one or more transport layers;
providing access to the network protocol from the open standard meter communication protocol stack; and
providing methods for sending and receiving data to other communication nodes in the advanced metering system.

2. A method as in claim 1, wherein said method further comprises:
developing a transport layer; and
providing a common base class for reuse in development of such transport layer.

3. A method as in claim 1, further comprising a step of providing access to a standard logging mechanism.

4. A method as in claim 1, further comprising a step of providing access to common instrumentation.

5. A method as in claim 1, further comprising a step of providing access to network interface management including status and diagnostic reporting.

6. The method of claim 1, further comprising a step of accommodating variable length messages.

7. A method as in claim 1, whereby said method of interfacing among layers provides a configurable security interface.

8. A method as in claim 1, wherein said interface is implemented in a .NET framework.

9. A method as in claim 1, wherein the one or more transport layers capable of being plugged into a developed transport layer interface comprise one or more of Transmission Control Protocol/Internet Protocol (TCP/IP) and User Datagram Protocol (UDP) transport layers.

10. A method as in claim 1, further comprising a step of providing at least some of the plurality of communication nodes as meters having one or more of GPRS, Ethernet, and RF LAN communications modules.

11. A method as in claim 1, further comprising a step of sending messages out a network interface, and listening for incoming messages on ports associated with one or more communication nodes.

12. A method as in claim 1, further comprising a step of assembling messages into complete application responses.

13. A method as in claim 1, further comprising a step of providing asynchronous message processing including message queues and thread management for port listeners.

14. A method as in claim 1, further comprising steps of respectively providing positive or negative acknowledgement of messages sent to or received from another communication node in the advanced metering system.

15. A method as in claim 1, further comprising the steps of:
maintaining a given native network address; and
notifying one or more host applications if the given native network address changes.

16. An advanced metering system including a native network interface for interfacing among selected layers in an open standard meter communication protocol stack, comprising:
a plurality of end devices, at least some of which end devices comprise metrology devices; and
a network including a central facility comprising a collection engine, said network being configured for bi-directional communications between said central facility and each of said plurality of end devices, said bi-directional communications occurring at least in part based on an open standard meter communication protocol; and
a network interface provided for operation on processors associated with selected ones of said plurality of end devices and said collection engine, said network interface providing access to the network protocol of said open standard meter communication protocol.

17. An advanced metering system as in claim 16, wherein said network interface is configured to provide an ability to plug in one or more low level network transport layers.

18. An advanced metering system as in claim 16, wherein said network interface is configured to provide access to a standard logging mechanism, common instrumentation, and interface management including status and diagnostic reporting.

19. An advanced metering system as in claim 16, wherein said network interface is implemented in a .NET framework.

20. An advanced metering system as in claim 16, further including:
one or more communication nodes associated with said plurality of end devices; and
wherein said network interface is further configured to send messages out a network interface, and to listen for incoming messages on ports associated with said one or more communication nodes associated with said plurality of end devices.

21. An advanced metering system as in claim 20, wherein said network interface is further configured to assemble messages into complete application responses for sending positive or negative acknowledgement of messages sent to or received from another communication node in the advanced metering system.

22. An advanced metering system as in claim 16, wherein said network interface is further configured to provide asynchronous message processing including message queues and thread management for port listeners.

23. An advanced metering system as in claim 16, wherein said network interface is further configured to maintain a given native network address and to notify one or more host applications if the given native network address changes.

24. An advanced metering system as in claim 16, wherein said metrology devices comprise meters having one or more of GPRS, Ethernet, and RF LAN communications modules.
